(19) United States
(12) Patent Application Publication
(10) Pub. No.: US 2014/0101529 A1
(43) Pub. Date: Apr. 10, 2014

(54) Link Building

(71) Applicant: 4TH ASPECT LIMITED, Houghton le Spring (GB)

(72) Inventor: Paul David Curran, Tynemouth (GB)

(73) Assignee: 4TH ASPECT LIMITED, Houghton le Spring (GB)

(21) Appl. No.: 13/644,858

(22) Filed: Oct. 4, 2012

(51) Int. Cl. G06F 17/00

(52) U.S. Cl. 715/234

(57) ABSTRACT

An engine (1601) for link building in order to improve the visibility of a website to search engines is disclosed. Back links are generated that represent links from other websites, such as directories, to the website under consideration. Prospect directories are identified by identifying volumes of candidate directories and initiating an iterative search of these candidate directories. Candidate directories are dismissed that are already under consideration. Candidate directories are rejected in response to preselected criteria which continues until a proposed list (1604) up to a predetermined lists size has been generated. It is a technical aid to assist with the manual building of quality links and not a tool for bulk link submission.

### CROSS REFERENCE TO RELATED APPLICATIONS

This application claims priority from United Kingdom Patent application number 11 18 395.1 filed Oct. 25, 2011, the entire disclosure of which is incorporated herein by reference in its entirety.

### BACKGROUND OF THE INVENTION

1. Field of the Invention

The present invention relates to a system for link building by establishing back links to client websites. The present invention also related to a method of promoting websites by establishing back links.

2. Description of the Related Art

In recent years the use of search engines for the identification of appropriate websites has become well established. Often, customers will look for an appropriate website by entering a vague request into a search engine. Thus, search engines have become powerful tools and vendors are under pressure to develop websites that search engines suggest to customers and rank highly.

Many known techniques are available for improving the visibility of websites to search engines and much advice is available from many of the search engine organisations themselves. One of these techniques involves an assessment of the number of back links present for a particular website. Back links represent links from other websites, such as directories, to the website under consideration.

Many of these directories and similar overseeing websites provide mechanisms for these back links to be established; they are effectively allowing the providers to populate the directory service. However, in many instances, measures are included to prevent the automated population of such directories such that human intervention is required. Furthermore, it is also known that many automated techniques result in less than optimal back linking strategies. However, if all of the back linking is to be done manually the exercise becomes time consuming and is susceptible to the introduction of errors.

### BRIEF SUMMARY OF THE INVENTION

According to an aspect of the present invention, there is provided a system for establishing back links to websites. The system comprises a bureau computer having a storage device configured to store a first database of candidate websites that are candidates for back linking. In addition, a second database is provided of directory content along with a network interface. A website promoting computer is provided and a plurality of directory website servers. The bureau computer is configured to supply, via said network interface, directory website content data to each one of said plurality of website promoting computers. Each website promoting computer is configured to display, to an operator, said directory website content data. The website promoting computer is configured to conduct a data populating exercise with a selected one of the plurality of directory website servers in response to an input received from an operator.

The first database may include generic candidate directory websites appropriate for many campaigns and specific candidate directory websites.

According to a second aspect of the present invention, there is provided a method of promoting websites by establishing back links. Method comprises steps of maintaining a first database of candidate directory websites for back linking, maintaining a second database of directory content and supplying directory data identifying a plurality of directory websites to be populated to each of a plurality of website promoting computers. In addition, the method also comprises supplying content data for a specific directories identified by a website promoting computer and maintaining a record of campaigns being conducted by each of the website promoting computers to facilitate operator interaction with each of the website promoting computers.

In an embodiment, the second database includes directory content for a plurality of fields and a plurality of directory content items may be stored for each of these fields.

According to a third aspect of the present invention, there is provided a method of presenting prospect directories to a website promoter, comprising the steps of: identifying volumes of candidate directories; initiating an iterative search of said candidate directories; dismissing candidate directories that are already under consideration; rejecting candidate directories in response to preselected criteria; and building a proposals list up to a predetermined list size.

### BRIEF DESCRIPTION OF THE DRAWINGS

FIG. 1 shows an internet environment;

FIG. 2 shows a protocol diagram illustrating a conventional interaction with a search engine;

FIG. 3 illustrates a known approach to link building;

FIG. 4 identifies an embodiment of the invention in which the hardware of FIG. 3 has been used to implement a new configuration;

FIG. 5 shows a hierarchy for a promotions bureau providing services to promoters;

FIG. 6 illustrates a protocol diagram for operations performed within the environment of FIG. 4;

FIG. 7 illustrates apparatus for establishing a promotions bureau;

FIG. 8 illustrates operations performed by the processor identified in FIG. 7;

FIG. 9 illustrates operations performed by a promoter when cooperating with a bureau;

FIG. 10 illustrates a first display shown to a promoter;

FIG. 11 shows a second display shown to a promoter;

FIG. 12 shows an example of content data;

FIG. 13 shows a logical expression defining the procedure for making a directory selection;

FIG. 14 shows a set up procedure for a process for implementing the selection process identified in FIG. 13;

FIG. 15 details an implementation of the logical expression identified in FIG. 13 and

FIG. 16 shows an overview of the link in process.

### DETAILED DESCRIPTION OF EXAMPLE EMBODIMENTS

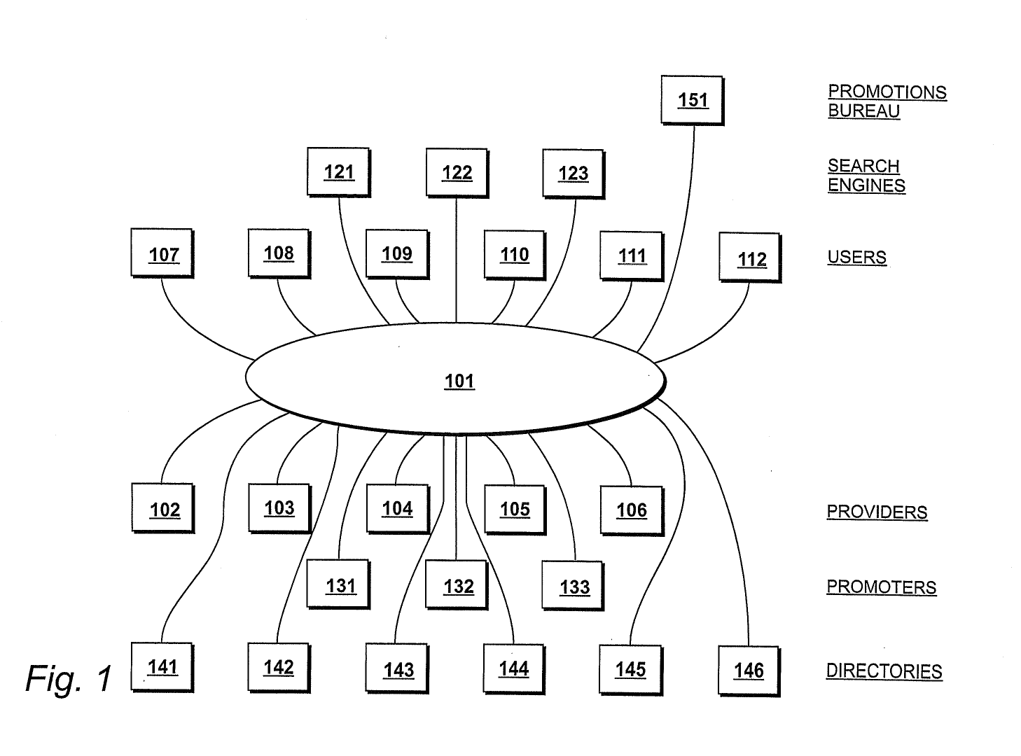

FIG. 1

An Internet environment is illustrated in FIG. 1. An international communications network 101, such as the worldwide web, facilitates communications from provider websites 102, 103, 104, 105, 106 etc back to requesting users 107, 108, 109, 110, 111 and 112. Thus, as is well known in the art, a user, such as user 107, may issue a URL address via a browser to a provider, such as provider 102, resulting in a webpage being returned back to user 107. For the purposes of this example, user 107 may be looking to initiate a commercial transaction and having identified website 102 it is then possible for the transaction to take place.

For the purposes of this example, many of the providers, possibly all of providers 102 to 106, could have completed the commercial transaction with user 107. User 107 identified provider 102 but it is possible that a better relationship may have been possible elsewhere. Thus, for the purposes of this example, user 107 may have been in a position to make a more attractive purchase from provider 105.

To facilitate the identification of an appropriate provider (via that provider's website) search engines, such as search engines 121, 122 and 123 have become established. A user, such as user 107, may submit an identification of their interests to search engine 121, say, which in turn results in a plurality of providers being listed in a ranked order. Thus, for the purpose of this example, search engine 121 may have identified provider 105 as an attractive source and as such website 105 is listed at the top of a listing provided to user 107 via search engine 121.

Clearly, in this example, provider 102 has lost a sale therefore provider 102, and other providers in the environment, may be motivated to enhance their position in listings generated by search engines, such as search engine 121.

To assist with this process of enhancing search-engine-generated list positions, a procedure often referred to as search engine optimisation (SEO), promoters, such as promoters 131, 132 and 133 have become established who will take measures to enhance the attractiveness of websites; such that they appear higher in rankings produced by search engines. Many techniques are known for achieving this but the present embodiment is directed towards increasing the number of back links present within the websites of a provider.

Back links are available from directories and other web presences such as social networks etc or any website where it is possible for a back-link to be created. Thus, in the environment of FIG. 1, directories 141, 142, 143, 144, 145 and 146 are present. For the purposes of this example, it is assumed that directories 141, 142, 143 and 144 provide listing services and entries that are relevant to the services provided by provider 102. Thus, provider 102 would benefit from each of these directories (141 to 144) including on their website a link back to the website of provider 102; a back-link. For the purposes of this example, it is assumed that it would be inappropriate for provider 102 to have a back-link from directory 145 and directory 146.

It is well established that good quality one way incoming links from external websites substantially help with the search engine ranking of a website. To be effective, these back links should be achieved consistently and relatively slowly over a period of time. It is also desirable to have a good mix of back links, such as incoming links from social media sites and links from customer sites, in addition to the links from good quality reference sites such as business or special interest directories.

It is time consuming to find websites that will allow a link to be posted back to a provider website and then to complete the form necessary to complete the submission process. An embodiment facilitates the establishment of a steady number of business and special interest directory links on an ongoing basis.

For the purposes of this example, provider 102 has selected promoter 131 to assist with the ongoing development of their website. Promoter 131, should, as part of this process, establish back links with directories 141 to 144. In practice, the number of links of this type would be substantially more and the process would require significant work on the part of promoter 131.

Using a conventional approach, promoter 131 may invoke local automated procedures for establishing links. Such procedures are relatively wide ranging and are difficult to tune in order to be selective. Thus, under these circumstances, there is a high probability that back linking would also be established with directories 145 and 146; which is seen as commercially undesirable. However, using known techniques, substantial manually intervention would be required on the part of promoter 131 in order to identify directories 141 to 144 while avoiding directories 405 and 406.

The present embodiment includes a promotions bureau 151 to substantially enhance the link building actives of promoters 131 to 133. However, it still allows manual intervention by the promoters. Furthermore, by maintaining connections through the promoters, the activities of the bureau are hidden and thereby avoid the intervention of automated process detection measures.

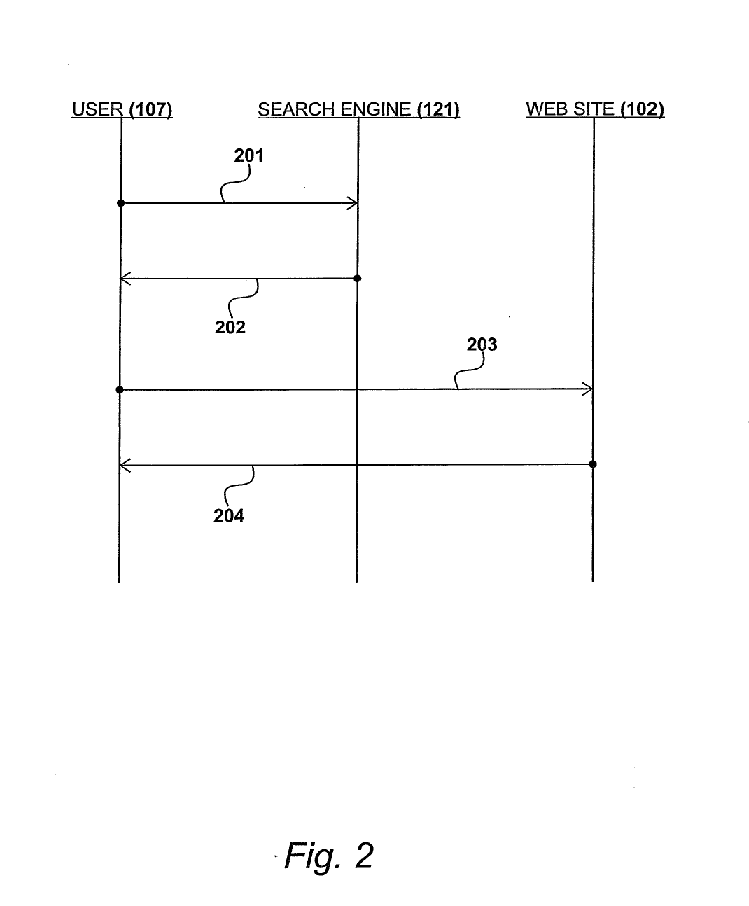

FIG. 2

A protocol diagram illustrating a conventional interaction with a search engine is illustrated in FIG. 2. A user, such as user 107, initiates a request 201 to a search engine, such as engine 121, in the form of a string of text. The search engine 121 analyses this text to identify the most appropriate providers, ranked in order. Thus, data 202 is returned back to the user identifying this ranked list.

In response to reviewing the ranked list, the user makes a selection, resulting in a request 203 being sent to the requested website. Data 204 representing the selected webpage is then returned back to the user 107.

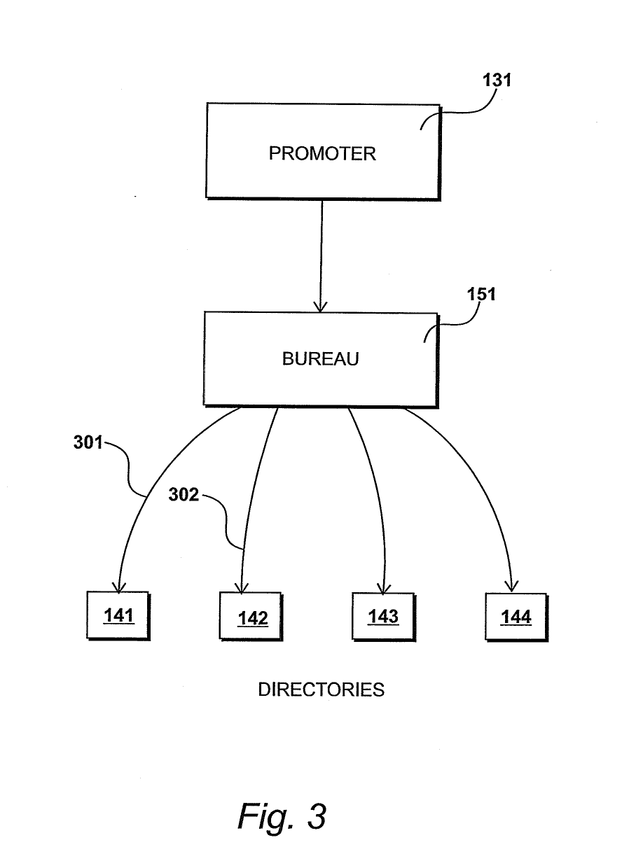

FIG. 3

A promoter 131, in this example, as been commissioned by provider 103 to enhance the visibility of provider website 103. Promoter 131 has instructed bureau 151 to assist by creating back links from directories 141 to 144. The promoter 131 is responsible for the development of the provider website 103 and as such promoter 131 has access to this website. Bureau 151 has details of directories and may make attempts, 301, 302 etc to communicate with these directories and create back links. However, problems occur in that bureau 151 is somewhat removed from access to websites maintained by promoter 131. As such, difficulties will occur, often due to security provisions, when bureau 151 attempts to create these back links for what the environment will perceive as a website belonging to a third party. Consequently, the structure of FIG. 3 is not effective, unless bureau 151 takes over the role of promoter 131. Consequently, there is little bureau 151 can do in order to assist the activities of promoter 131.

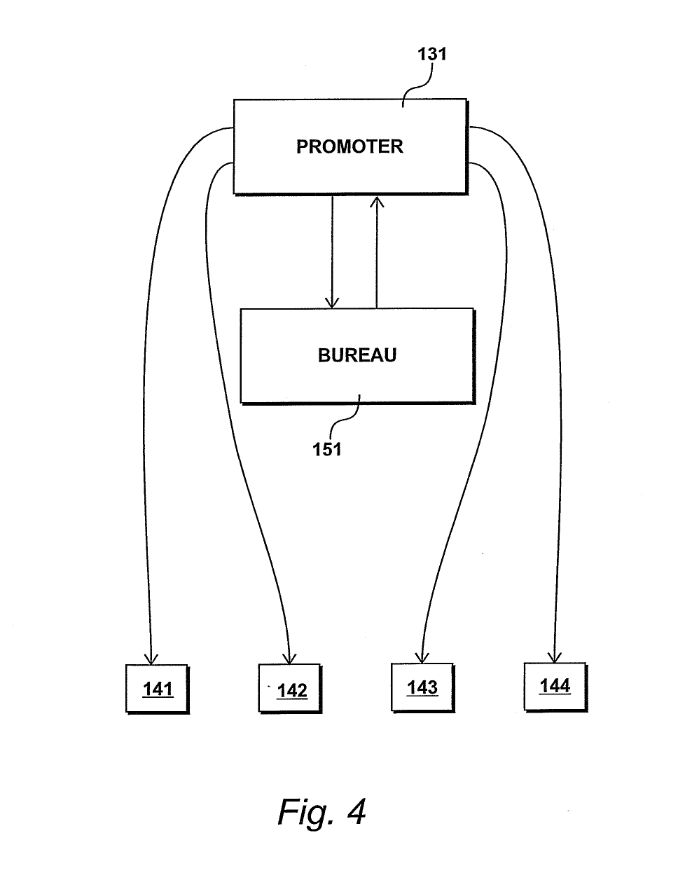

FIG. 4

An embodiment of the present invention is identified in FIG. 4. The system, in this new configuration, provides for link building by establishing back links to client websites. Thus, as previously explained, provider websites, such as that of provider 103 strive to be more visible when searches are produced by search engines, such as search engine 121. To achieve this, a promoter, such as promoter 131, strives to create back links, in which a link is established from a directory, such as directory 141, to provider 102; without provider 102 generating a reciprocal link back to directory 141.

A bureau computer 151 has a storage device that is configured to store a first database of directory websites that are candidates for back linking, along with a second database of directory content. The website promoting computer 131 is present, along with a plurality of directory website servers 141 to 144.

The bureau computer is configured to supply, via a network interface, directory website content data to the website promoting computer 131. The bureau computer 151 usually has relationships with many promoters and would communicate with a plurality of website promoting computers. The website promoting computer 131 is configured to display, to an operator, the directory website content data. The website promoting computer is configured to conduct a data populating exercise with a selected one of said plurality of said directory website servers (141) in response to an input received from an operator.

In an implementation, the promoter 131 looks at web pages generated by bureau 151 via their browser. Instructions are installed on each promoter computer (131 to 133) which, in an implementation, is a web browser extension. In this way, it is possible for bureau 151 to control the population of directory websites but from the perspective of these directory websites, the operations are being performed by the promoter computer 131.

To initiate the process, promoter 131 may install a sidebar extension by downloading it from a website supported by the bureau 151. This in turn presents details of campaigns that are currently being worked on by the promoter 131, allowing a selection to be made such that the promoter 131 is then presented with details of links that are to be submitted. Thus, by adopting the topology of FIG. 4, as distinct of that of FIG. 3, it is possible to provide significant technical assistance to individual promoters 131, while still allowing promoters 131 a degree of control without encountering technical problems because the submission of data to, say, directory 141, is still overseen by the promoter 131. The bureau 151 does not attempt to make direct contact with directory 141 as such an approach would often encounter security restrictions. However, bureau 151 perform most of the time consuming work while relaying this activity to promoter 131 and remaining under the control of promoter 131.

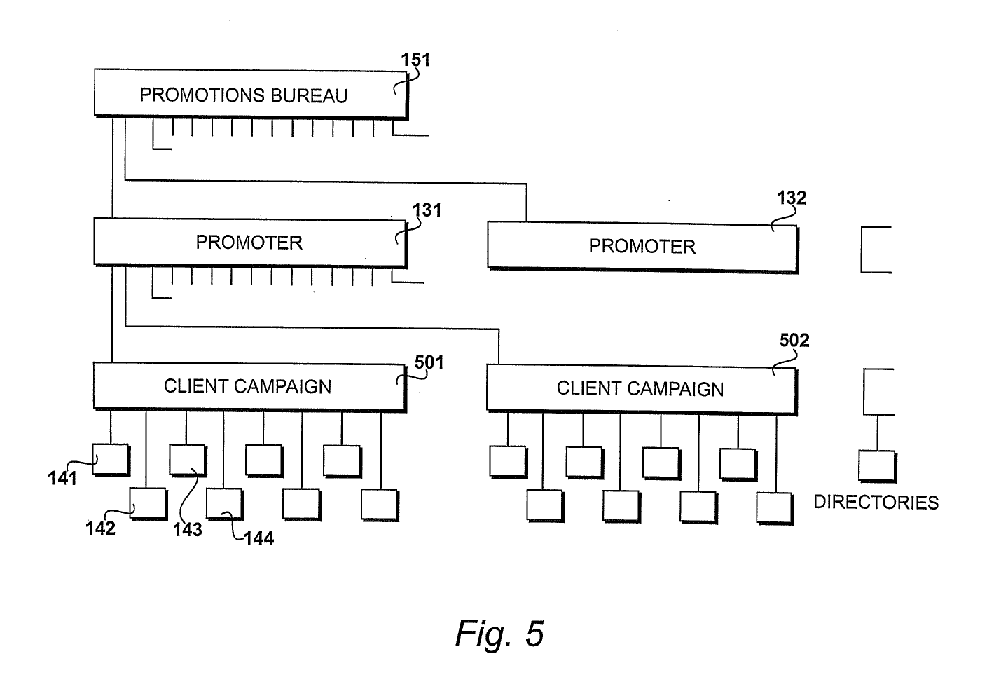

FIG. 5

An example of a hierarchy is illustrated in FIG. 5. A promotions bureau 151 provides assistance to many promoters, including promoter 131 and promoter 132.

Each promoter, such as promoter 131, is involved in a plurality of campaigns, including campaign 501 (which may be for provider 103) and campaign 502, which may be for provider 104.

Over a period of time, each campaign, such as campaign 501, will attempt to establish back links with a plurality of directories or similar websites, including directories 141 to 144. Submissions to directories are usually restricted, typically to around twenty submissions per month, as more could alert search engines to the effect that something unnatural is occurring. Problems of this type often happen when a bulk purchase of one off link building occurs.

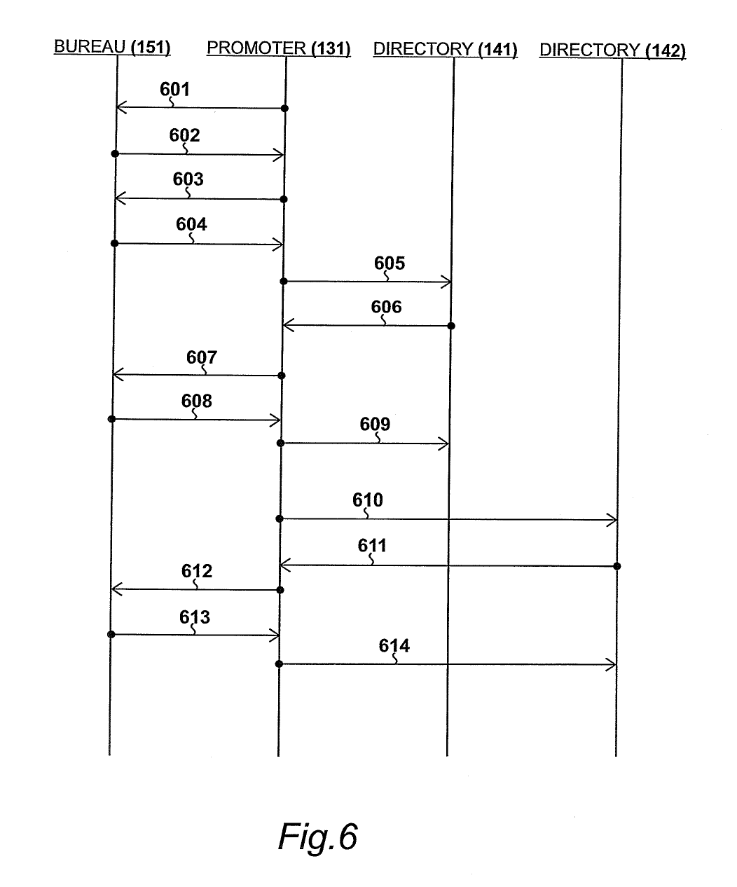

FIG. 6

A protocol diagram for operations performed within the environment of FIG. 4 is illustrated in FIG. 6.

Initially, a promoter 131 views the website of bureau of 151. The clicking of a link builder tab results in a request 601 from the promoter to the bureau resulting in data 602 being returned identifying existing link building campaigns. From this page it is also possible to initiate a new campaign having previously identified a provider's website of interest; the provider being a client of the promoter.

Data 603 from the promoter selects a particular campaign, resulting in data 604 being returned from the bureau to the promoter listing candidate websites for back links to be created.

In response to manual selection, a request at 605 is made to a first directory 141. The directory 141 returns field data 606, identifying the particular fields that require to be populated within the directory in order for a back link to be established. Thus, the populating of these fields represents a substantial overhead in relation to the overall link building process. However, in an embodiment, data for the populating of these fields is generated by the bureau 151, while requiring the acceptance of the submission by the promoter 131 such that it is the promoter 131; who is seen as the entity making the actual submission to the directory 141.

Consequently, data 607 is sent back to the bureau 151 representing the field data 607 received from directory 141. Thus, Content data 608 is then sent back to the promoter 131 from the promoter 151 which is displayed to an operator at the promoter 131. The operator reviews this content data and if acceptable, a transmission 609 of the content data is relayed to the directory 141.

The promoter 131 is now in a position to move on to the next directory. Thus, address data 610 addresses the next directory, resulting in field data 611 being returned back to the promoter 131. A transmission 612 relays this field data back to the bureau 151 which in turn returns content data 613. Content data is reviewed by an operator and upon being approved, a transmission 614 relays the content data to the directory 142.

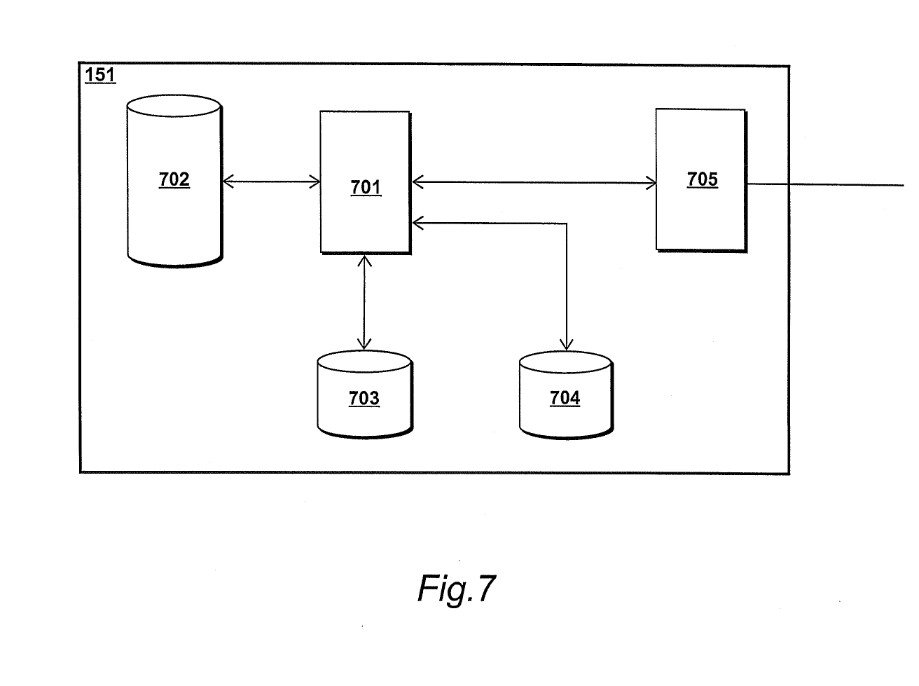

FIG. 7

Apparatus 151 for establishing the promotions bureau 151 and allowing the bureau to assist a web promoting computer (promoter 131) to perform search engine optimisation is detailed in FIG. 7. A processor 701 communicates with a first database 702 which contains website addresses for supplying first data of candidates to the web promoting computer, which in turn will be responsible for establishing the back links to a provider website that is being optimised. A second database 703 contains candidate content for supplying second data to the web promoting computer to populate fields in a website that is providing a back link to the website being optimised. Furthermore, a third database 704 maintains third data of the activities performed by a web promoting computer. In an embodiment, further databases may be included recording candidates identified by the promoter. In an embodiment, this promoter generated data is private, possibly encrypted, and is only viewable by the originating promoter.

Thus, the first database includes web addresses of directory websites and other websites where it is possible to establish a beneficial back link. In an embodiment, the first database may undergo regular updating and contain a large volume of potential candidates; not all of which would be appropriate for each specific campaign.

In an embodiment, the second database 703 includes variants of substantially similar data content appropriate for a particular field entry. Thus, although field types received from different directory websites may be substantially equivalent, and could be populated with similar content, in an embodiment, measures are taken to store multiple examples of content in the second database 703 such that different content may be deployed while effectively conveying substantially similar information.

Processor 701 communicates with network 101 via a network interface 705. Details from a candidate website (directory) that has been contacted by a promoting computer (such as promoter 131) are received from the promoting computer, via interface 705, as field data. In response to this field data, the second database 703 supplies second data to the promoting computer. The third database 704 is populated with data identifying the population of websites providing back linking, in response to receiving field data. Thus, the reception of field data confirms that a candidate website has been contacted. The bureau 151 therefore keeps track of the back linking websites that have been contacted so that on a subsequent iteration, updated lists are provided to the promoter 131. In this way, it is not necessary for the promoter to manage the overall operation of contacting external websites because this management function is maintained by the bureau 151. The processor 701 will also restrict the number of contacts that can be made to a predetermined number over a predetermined timeframe.

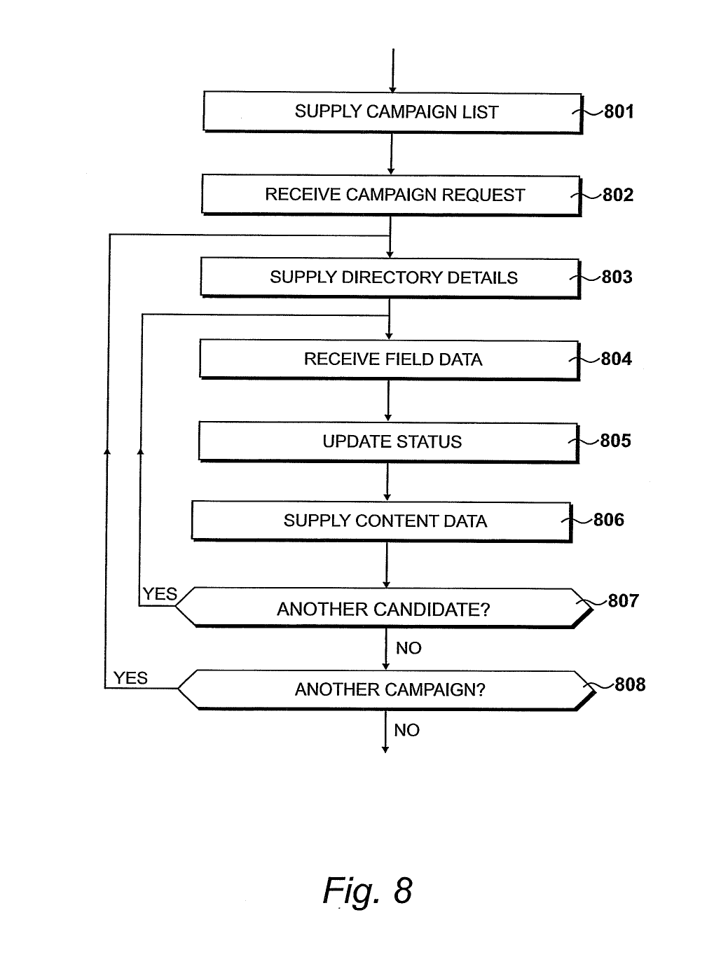

FIG. 8

Operations performed by processor 701, at the bureau 151, are detailed in FIG. 8. The procedures invoke a method of promoting websites by establishing back links. As previously described, at the bureau 151 a first database is maintained of candidate directory websites for back linking. A second database is maintained of directory content. Directory data is supplied identifying a plurality of directory websites to be populated to each of a plurality of website promoting computers. The method also maintains a record of the campaign being conducted by each of the website promoting computers to facilitate operator interaction with each said website promoting computer.

At step 801 the bureau 151 supplies a campaign list to a promoter. Following this, the bureau receives a campaign request at step 802.

In response to a particular campaign being identified, directory details are supplied at step 803. The first database includes generic candidate directory websites appropriate for many campaigns, along with specific candidate directory websites identified by a particular promoter.

In an embodiment, candidate details are maintained for each campaign, using the third database 704.

At step 803 directory details are supplied and the promoter would then make contact with a particular directory website resulting in the generation of field data; that is to say identifying requesting the input of field content. This field data is relayed back to the promoter 131 therefore the field data is received at step 804.

The status of the campaign is updated at step 805, resulting in an entry being made in the third database 704 to the effect that, for a particular campaign, a particular candidate website has been contacted.

At step 806, content data is supplied from a second database 703. The second database includes directory content for a plurality of fields. In an embodiment, a plurality of directory content items are stored for each field, allowing different content to be supplied to fields that are substantially similar.

Thus, data is received representing an input page request from the promoting computer which is analysed to identify appropriate content data.

The content data is supplied to the promoter at step 806. At step 807 a question is asked whether another candidate is to be considered and when affirmative, further field data is received at step 804. If negative, a question is asked at step 808 as to whether another campaign is to be considered and when affirmative further directory details are supplied at step 803.

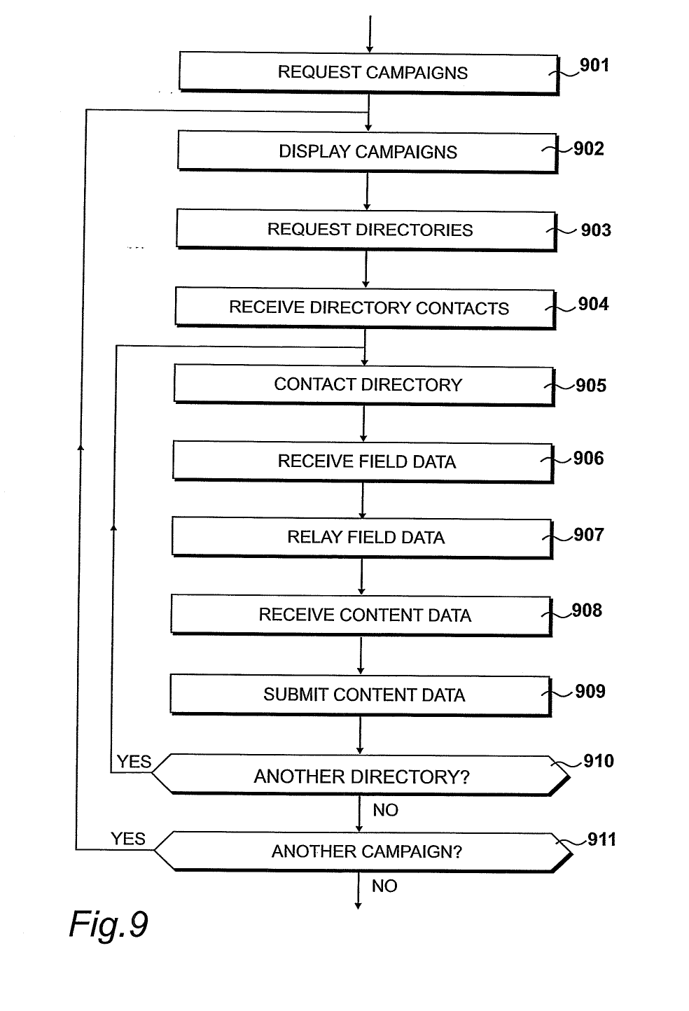

FIG. 9

In cooperation with the bureau 151, the promoter 131 invokes a method of promoting websites by establishing back links from candidate websites, including directories. Directory data is received identifying a plurality of directory websites to be populated from a bureau computer. Content data is received from the bureau computer for selected directory websites. The content data is displayed for operator approval and submission. Confirmation is returned of said submission back to the bureau computer.

Having established a connection to the bureau 151, the promoter 131 requests details of current campaigns at step 901. Consequently, details of these campaigns are displayed at step 902.

In response to the campaigns being displayed, a specific request 903 is made for directories to the bureau 151. In response to this request, directory contacts are received at step 904.

At step 905 a directory is contacted (a candidate website) resulting in field data being received at step 906, representing a request for contact data to be entered in the appropriate field.

At step 907 the field data is relayed from the promoter 131 to the bureau 151. At step 908 content data is received from the bureau and at step 909 a submission is made, after receiving operator approval.

At step 910 a question is asked as to whether another directory is to be considered and when affirmative, a further directory is contacted at step 905. When negative, a question is asked at step 911 as to whether another campaign is to considered. When affirmative, the current campaigns are again displayed at step 902.

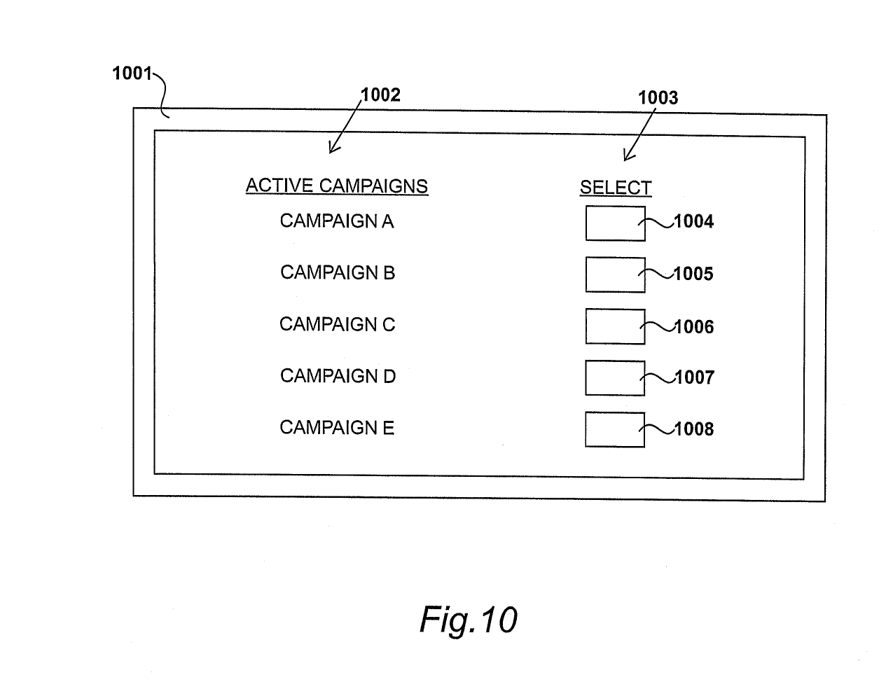

FIG. 10

A display 1001 is shown in FIG. 10, generated in response to step 902 at the promoter resulting in campaigns being displayed. A first column 1002 lists active campaigns and a second column 1003 allows a selection to be made. In this example, five campaigns are current, identified as campaign A, campaign B, campaign C, campaign D and campaign E. Each has a respective checkbox 1004 to 1008. Thus, in response to the campaigns being displayed, an operator may select campaign C by the checking of box 1006, or by a similar appropriate interface operation.

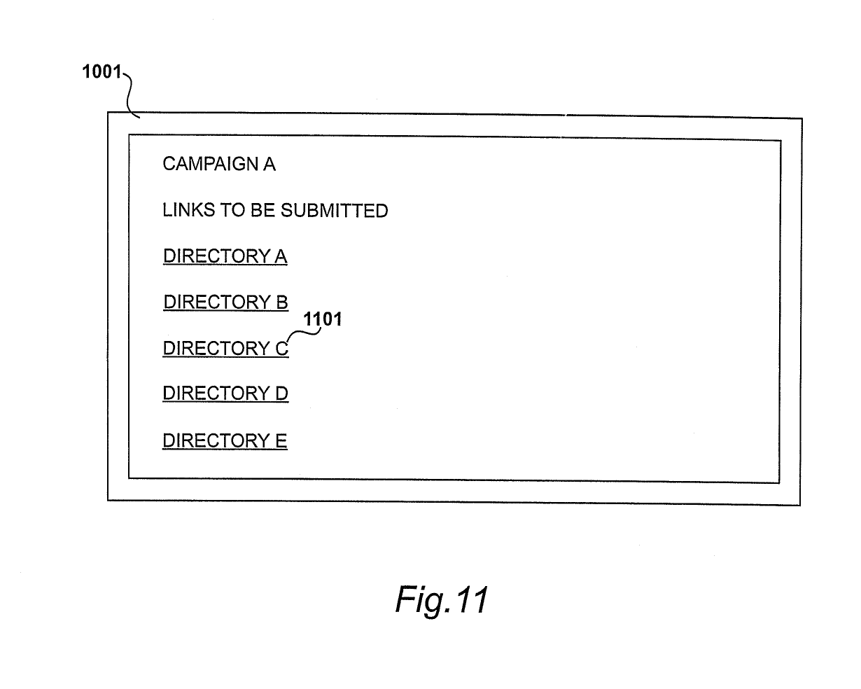

FIG. 11

Display 1001 is also shown in FIG. 11, following the operation of step 9004 and having received directory contacts, these directory contacts are displayed.

The bureau 151 manages the submission of requests for back linking and as such it is not necessary for the promoter 131 to manage and oversee this operation. As a consequence of this, it is not necessary to provide a complete list of all the links in the campaign. At any point in time, a number of links to directories will be awaiting submission. In an example, the bureau 151 may identify twenty directories per month. Thus, at the start of each month, at least twenty directories will be identified in FIG. 11. In this example, some submissions have been made therefore it is assumed that fifteen links have been established for the month under consideration and five further, as illustrated remain open. Thus, a mouse clicking operation performed with respect to “directory C” 1101 will result in contact being made with the website for directory C.

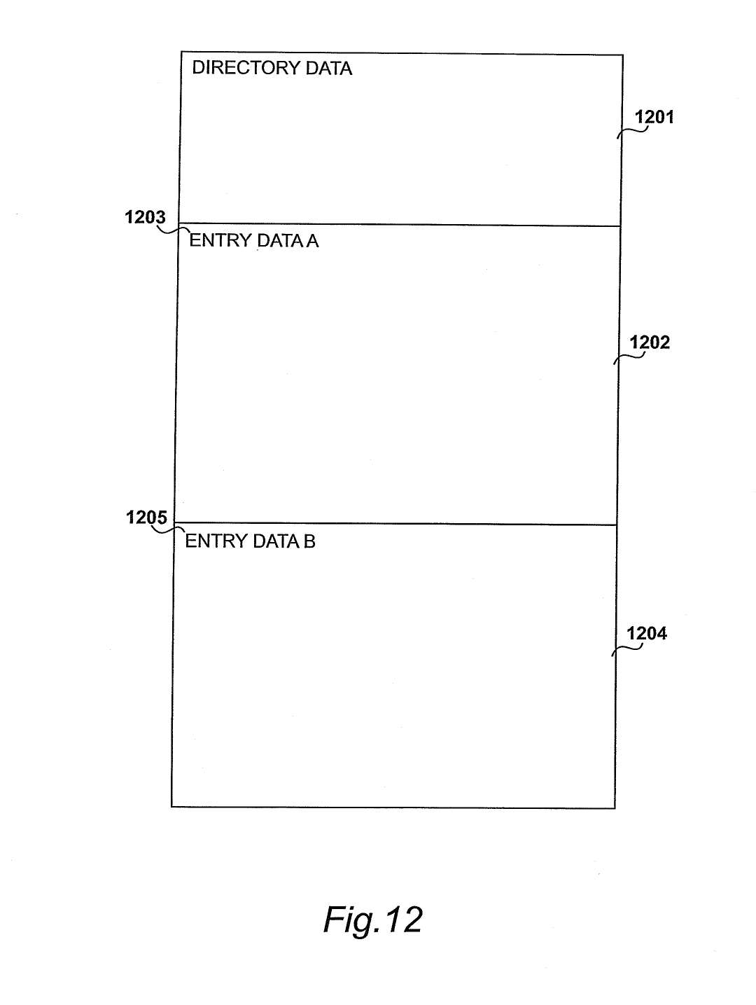

FIG. 12

An example of content data is shown in FIG. 12, of the type received at step 908 and submitted at step 909. Field 1201 identifies data relating to the directory itself and will have been generated by the directory, say directory 141.

Field 1202 contains content 1203 received from the bureau 151. Field 1204 includes more detailed information 1205 received from the bureau 1501. Thus, field data identifies the existence of fields 1202 and 1204, identifying the type of content data that is required. The actual content data 1203 and 1205 is derived from the second database 703, such that the time consuming work of data creation is performed by the bureau 151, but overseen by the promoter 131 before being approved and submitted. In this way, the technology substantially reduces the burden placed on the promoters, while maintaining an involvement of the promoters and bypassing technical limitations that prevent the automated population of directory fields.

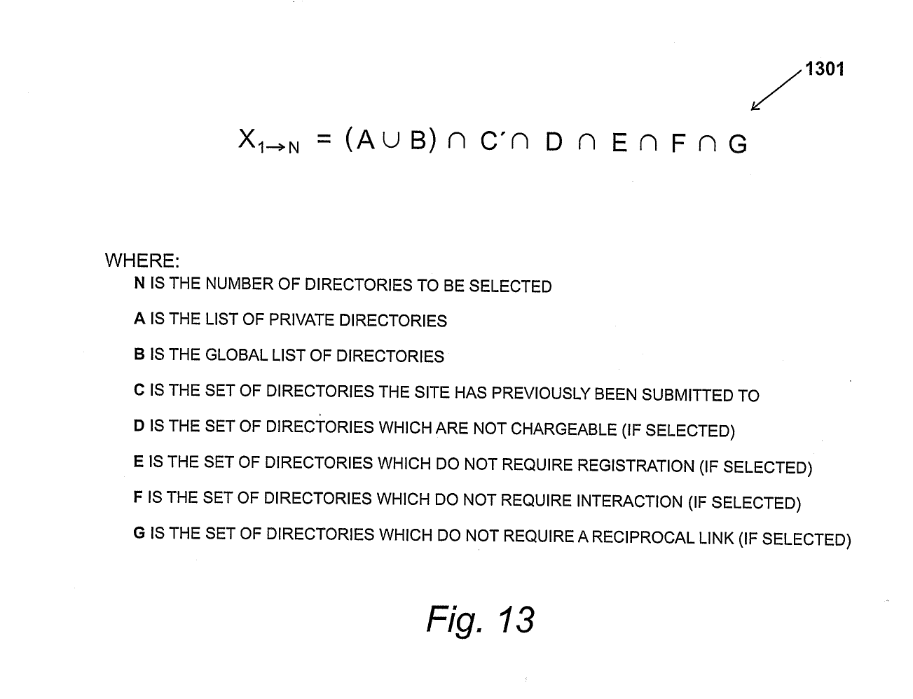

FIG. 13

In an embodiment, candidate directory websites are retained at the promotions bureau 151 and selections may be made from private tables, possibly provided by a promoter and from global tables maintained by the promotions bureau. As illustrated in FIG. 8 at (803) directory details are supplied from the promotions bureau 151 and as illustrated in FIG. 9 (at 904), these directory contacts are received by the promoter. The promoter is then responsible for promoting each individual campaign, such as campaign 501 and the system will prompt them, periodically, to maintain a back link building procedure. Thus, each month, suitable link directories must be identified for each campaign under consideration.

The technical assistance provided by the current system is directed towards assisting promoters with the manual building of quality links and it should not be confused with a tool for bulk link submission. The tool therefore aims to optimise procedures that may be automated with procedures that are best conducted manually by the promoters themselves.

From the available candidate directories, a list of proposed directories will be identified and conveyed to the promoter for a particular campaign. The procedure for making this selection is identified by the logical expression 1301 identified in FIG. 13. Thus, for each individual submission X (which is repeated N times) the appropriate list of private directories A may be unified with the global list of directories B present at the bureau.

The procedure considers all available candidate directories, in an embodiment, therefore directories that have been submitted previously are dismissed; shown in the expression as C′.

Thereafter, a number of variable constraints are considered. Firstly, directories D that do not require a charge may be considered preferable to those where a charge is required. Similarly, directories E that do not require a registration may be considered more desirable than those that do. Directories F that do not require interaction, requiring manual key presses in response to a displayed graphic for example, may be seen as preferable. Finally, in this example, but not exclusively, the set of directories G that do not require a reciprocal link may be considered preferable.

Thus, as shown in expression 1301, the union of the available directories, the private directories with the global directories in this example, is processed with the intersection of C′ representing the set of directories that have not previously been submitted, the intersection D of the set of directories that are not chargeable, with the intersection of E representing the set of directories that do not require registration, with the intersection of F representing the directories that do not require an interaction, with the intersection of G representing the directories that do not require a reciprocal link.

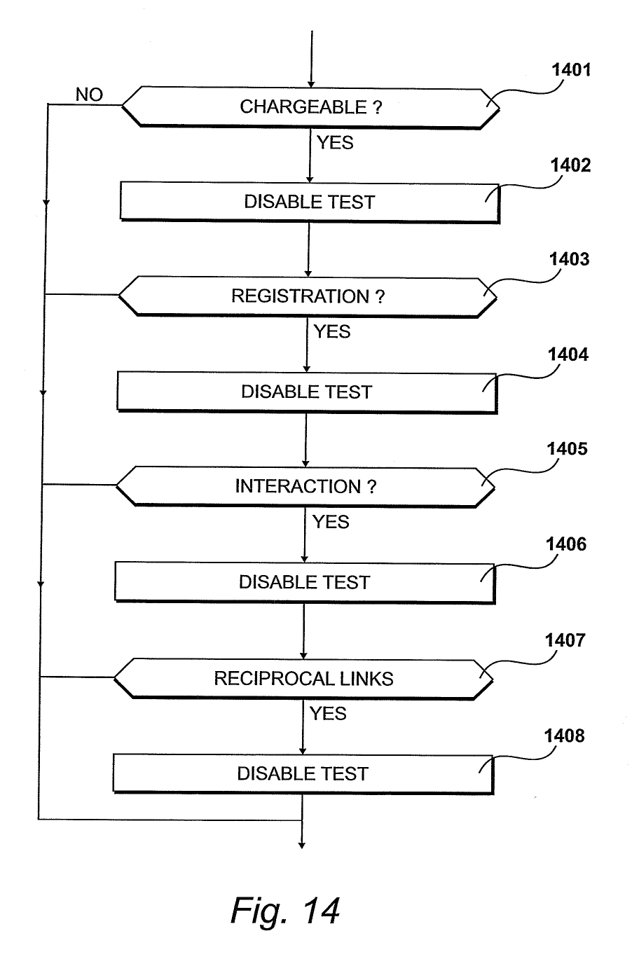

FIG. 14

Before executing the selection process, in accordance with logical expression 1301, a set-up procedure may be implemented, as illustrated in FIG. 14.

At step 1401 a question is asked as to whether directories requiring a charge are to be selected. When answered in the affirmative, the test including the intersection of D is disabled at step 1402.

At step 1403 a question is asked as to whether directories requiring registration are to be retained. When answered in the affirmative, the test considering the intersection of variable E is disabled at step 1404.

At step 1405 a question is asked as to whether the test for a requirement for interaction is to be retained. When answered in the affirmative, the test considering the intersection of set F is disabled at step 1406. At step 1407, a question is asked as to whether the set of directories requiring reciprocal links is to be retained. When answered in the affirmative, the requirement for the intersection of set G is disabled at step 1408.

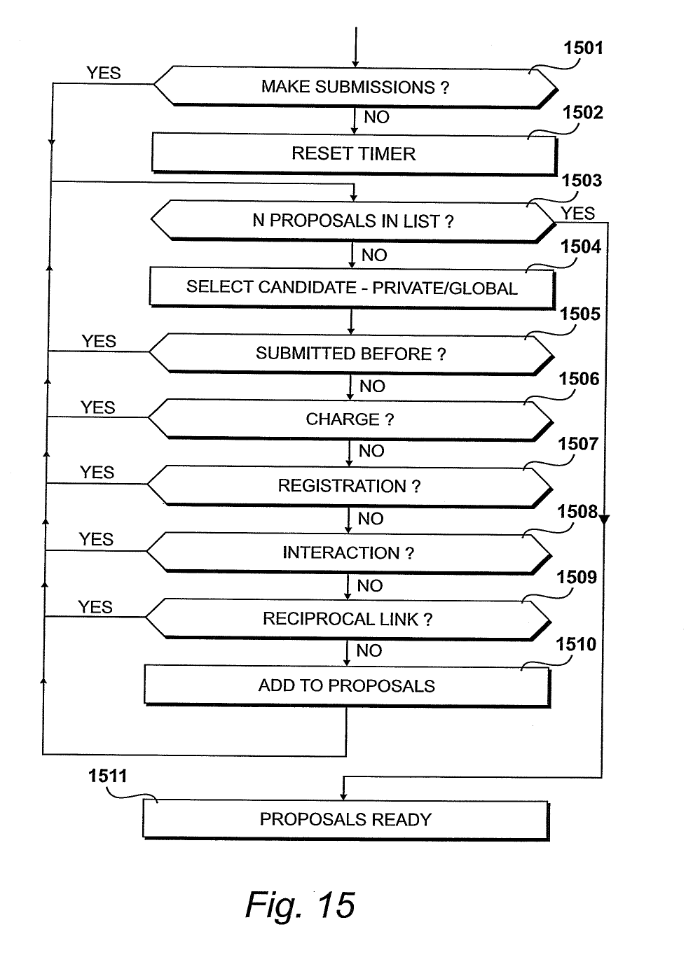

FIG. 15

The implementation of the logical expression 1301 is detailed in FIG. 15.

At step 1501a question is asked as to whether submissions are required. When answered in the negative, a monthly timer is reset at step 1502. When submissions are required, resulting in the question asked at step 1501 being answered in the affirmative, a question is asked at step 1503 as to whether any proposals are present on the list. On the first iteration, this will be answered in the negative. Thus, a candidate is selected at step 1504. This may consist of a selection made from just the private table, just the global table or from a combination of the private table and the global table.

At step 1505 a question is asked as to whether the directory has been submitted before. If answered in the affirmative, control is returned to step 1503 and the next candidate is selected. If the candidate has not been submitted before, resulting in the question asked at step 1505 being answered in the negative, a question is asked at step 1506 as to whether the selected candidate requires a charge to be made. Thus, again, when answered in the affirmative, control is returned to step 1503 and the next candidate is selected.

Assuming the question asked at step 1506 is answered in the negative, a question is asked at step 1507 as to whether a registration process is required. Again, if answered in the affirmative, control is returned to step 1503 and the next candidate is selected. If answered in the negative, to the effect that a registration process is not required, a question is asked at step 1508 as to whether an interaction is required. Again, when answered in the affirmative, control is returned to step 1503 and the next candidate is selected.

When the question asked at step 1508 is answered in the negative, a question is asked at step 1509 as to whether a reciprocal link is required. If answered in the affirmative, control is returned to step 1503 and the next candidate is selected. When answered in the negative, the proposal is added to the proposals list at step 1510 and control is returned at step 1503.

In an embodiment, the procedure of FIG. 15 will iterate until between ten and thirty candidates have been added to the proposals list. As described above, all of the filters remain active and none of the tests have been disabled, as may be possible following the set up procedures described with respect to FIG. 14.

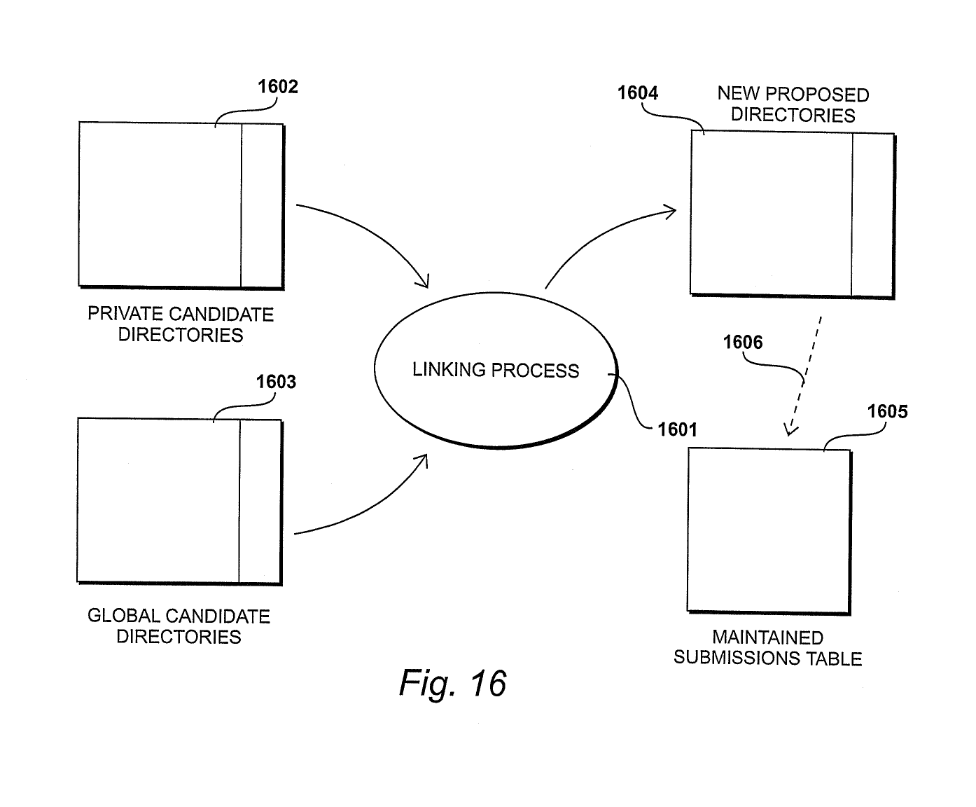

FIG. 16

The linking process, described with respect to FIGS. 13 to 15, is illustrated at 1601 in FIG. 16. This shows that the linking process receives candidate directories from a private candidate table 1602 and from a global candidate table 1603.

The linking process 1601 is performed, as previously described, in order to generate new proposed directories 1604. These, in an embodiment, are conveyed from the promotions bureau to the promoter. The promoter maintains a submissions table 1605 which identifies submissions for each campaign currently supported by that promoter. In particular, the submissions table 1605 maintains a status as to whether a submission is yet to be made, a submission is pending or a submission is verified as being in place. Thus, the system receives the new proposed directories 1604 and maintains the submissions table 1605.

However, the implementation from table 1604 (proposals) to table 1605 (actual submissions) is under the control of the manual promoter, as illustrated by dotted arrow 1606. In this way, it is possible to provide a technical aid to assist with the manual building of quality links in which a promoter maintains a quality assessment while being given technical assistance to reduce the introduction of human error. This level of assistance therefore distinguishes the system significantly from those concerned with the bulk submission of link generation.

What we claim is:

1. A system for establishing back-links to web-sites, comprising:
a bureau computer having a storage device configured to store a first database of candidate websites that are candidates for back linking, a second database of directory content and a network interface;
a website promoting computer; and
a plurality of directory website servers; wherein:
said bureau computer is configured to supply, via said network interface, directory website content data to each one of said plurality of website promoting computers,
each website promoting computer is configured to display, to an operator, said directory website content data, and
said website promoting computer is configured to conduct a data populating exercise with a selected one of said plurality of said directory website servers in response to an input received from an operator.

2. The system of claim 1, wherein said first database includes generic candidate directory web-sites appropriate for many campaigns and specific candidate directory web-sites.

3. The system of claim 2, wherein a specific candidate directory web-site is maintained for respective campaigns.

4. The apparatus of claim 1, wherein said second database includes directory content for a plurality of fields.

5. The apparatus of claim 4, wherein a plurality of directory content items are stored for each said field.

6. The apparatus of claim 1, further comprising a server device for supplying instructions to configure a remote computer to operate as a web-site promoting computer.

7. A method of promoting web-sites by establishing back links, comprising the steps of:
maintaining a first database of candidate directory web-sites for back linking;
maintaining a second database of directory content;
supplying directory data identifying a plurality of directory web-sites to be populated to each of a plurality of web-site promoting computers;
supplying content data for specific directories identified by a web-site promoting computer; and
maintaining a record of campaigns being conducted by each of said web-site promoting computers to facilitate operator interaction with each said web-site promoting computer.

8. The method of claim 7, wherein said first database includes generic candidate directory web-sites appropriate for many campaigns and specific candidate directory web-sites.

9. The method of claim 8, wherein a specific candidate database is maintained for respective campaigns.

10. The method of claim 7, wherein said second database includes directory content for a plurality of fields.

11. A method of presenting prospect directories to a web site promoter, comprising the steps of:
identifying volumes of candidate directories;
initiating an iterative search of said candidate directories;
dismissing candidate directories that are already under consideration;
rejecting candidate directories in response to pre-selected criteria; and
building a proposals list up to a predetermined list size.

12. The method of claim 11, wherein said identified volumes are selected by selecting a private table, a global table or a combination of said private table and said global table.

13. The method of claim 11, wherein said candidate directories are rejected based on a logically combined selection of criteria taken from one or more of the following, comprising: non-chargeability; non-registrability; non-interaction; and non-reciprocation.

14. Apparatus for assisting a web promoting computer to perform search engine optimisation, comprising:
a first database of web sites for supplying first data of candidates to said web promoting computer for providing back links to a provider web site that is being optimised;
a second database of candidate content for supplying second data to said web promoting computer to populate fields in a web site that is providing a back link to said web site being optimised; and
a third database for maintaining third data of the activities performed by a web promoting computer.

15. The apparatus of claim 14, wherein said first database includes web addresses of directory web sites.

16. The apparatus of claim 14, wherein said first database includes details of web addresses pre-defined by said web promoting computer.

17. The apparatus of claim 14, wherein said second database includes variants of substantially similar data content appropriate for a particular field entry.

18. The apparatus of claim 14, wherein:
details from a candidate web site contacted by said promoting computer are received from said promoting computer as field data; and
said second database supplies second data to said promoting computer in response to the reception of said field data.

19. The apparatus of claim 14, wherein said third database is populated with data identifying the population of web sites providing back linking in response to receiving said field data.

20. The apparatus of claim 14, wherein the number of candidates identified in said first data is restricted to a predetermined number over a predetermined time-frame.
